(19) United States
(12) Patent Application Publication
(10) Pub. No.: US 2022/0358585 A1
(43) Pub. Date: Nov. 10, 2022

(54) PROFILING ASSET ACQUISITION AGENT

(71) Applicant: Wells Fargo Bank, N.A., San Francisco, CA (US)

(72) Inventors: Melinda L. Li, San Francisco, CA (US); Aldo Anthony Ceccarelli, San Francisco, CA (US); A Erdem Cimen, San Francisco, CA (US); Rebecca S. MacDonald, San Francisco, CA (US); Jerry Wayne Johnson, San Francisco, CA (US); Chris Theodore Kalaboukis, San Jose, CA (US); Brian J. Jacobsen, Elm Grove, WI (US)

(21) Appl. No.: 15/666,991

(22) Filed: Aug. 2, 2017

(51) Int. Cl. G06Q 40/04; G06N 99/00; G06N 5/04

(52) U.S. Cl. CPC G06Q 40/04; G06N 99/005; G06N 5/047

(57) ABSTRACT

Systems and techniques for profiling asset acquisition agent are described herein. A target profile may be obtained. A set of profile attributes may be determined for the target profile. An acquisition target pool may be identified using the set of profile attributes. An acquisition matrix data structure may be generated for the acquisition target pool. An asset pool may be generated by acquiring equity of the acquisition target pool based on the acquisition matrix data structure.

### TECHNICAL FIELD

Embodiments described herein generally relate to automated asset acquisition and, in some embodiments, more specifically to a profiling asset acquisition agent.

### BACKGROUND

People may wish to make investments in securities that have a common theme. For example, a person may wish to invest in securities of companies operating in a particular business sector. A person may wish to invest in securities of companies that are used by a particular segment of the population. However, individuals in a particular segment of the population may use a variety of products and services of a variety of companies. Thus, it may be challenging to identify commonalities among the individuals.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and system for a profiling asset acquisition agent, according to an embodiment.

FIG. 2 illustrates a flow diagram of an example of a process for a profiling asset acquisition agent, according to an embodiment.

FIG. 3 illustrates an example of a profiling process for a profiling asset acquisition agent, according to an embodiment.

FIG. 4 illustrates an example of a process for profile adjustment for a profiling asset acquisition agent, according to an embodiment.

FIG. 5 illustrates an example of asset metric clustering for a profiling asset acquisition agent, according to an embodiment.

FIG. 6 illustrates an example of a graphical user interface for a profiling asset acquisition agent, according to an embodiment.

FIG. 7 illustrates an example of a method for a profiling asset acquisition agent, according to an embodiment.

FIG. 8 is a block diagram illustrating an example of a machine upon which one or more embodiments may be implemented.

### DETAILED DESCRIPTION

There may be a number of investment funds which may be focused on specific goals (e.g., funds targeting a specific business sector, target dates, tax minimization, etc.). However, traditional techniques for creating such funds may rely on manual creation. Some funds may be cause-based. However, they may not be micro targeted to specific interests or localities. The present techniques allow for the identification and acquisition of assets by an automated agent based on a community which may be geographically and/or interest based.

The community may be identified and data streams included in user profile data of community members may be analyzed to identify a target asset pool. Machine learning and deep learning techniques may be used to determine the assets to acquire. In an example, the target asset pool may be identified by evaluating user activities and extracting metrics (e.g., frequency of interaction with a company, volume of interaction with the company, sentiment towards the company, etc.) for each asset identified as corresponding with a user activity. The asset metrics may be aggregated and mapped in n-dimensional space. The map may be analyzed, by way of example and not limitation, using cluster analysis to identify commonalities between asset preferences of community members and strength of interest in the asset by the community as a whole.

Community preferences may be obtained by obtaining data from a plurality of data sources including transaction data, social media data, and other communication data. A profile may be generated for a community member by analyzing the activities (e.g., transactions, communications, etc.) included in the data. For example, a community member may frequently purchase coffee at a particular publicly traded coffee company and the transactions of the community member may be analyzed to determine a preference for the coffee company. Data for each community member may be analyzed. In an example, the data and preferences may be aggregated and evaluated to determine preferences for the community.

Community preferred assets may be included in a target asset pool. The data evaluation may include determining preference weights for assets in the target asset pool. For example, 75% of the community members may frequent coffee shop A, while 25% of the community members may frequent coffee shop B. Accordingly, coffee shop A may be weighted with a 3-1 ratio to coffee shop B. The weights may be used to generate an asset acquisition matrix for the target asset pool. The asset acquisition matrix may indicate proportions of assets to be acquired by the automated asset acquisition agent. For example, investors may have pledged $100,000 to be invested in the community preferred assets and the asset acquisition matrix may indicate that $75,000 in coffee shop A assets should be acquired while $25,000 of coffee shop B assets should be acquired.

The automated asset acquisition agent may use the pledged investment and the asset acquisition matrix to acquire the determined target assets. In an example, a graphical user interface (GUI) may be generated and provided to a fund manager, investor, etc. including the target asset pool and the asset acquisition matrix. The GUI may receive inputs from a user representing a modification to the target asset pool and/or the asset acquisition matrix. The inputs may be received and the automated asset acquisition agent may modify the asset acquisition matrix prior to acquiring the assets. The automated asset acquisition agent may generate a marketable security (e.g., an exchange-traded fund, mutual fund, etc.) based on the acquired assets. The marketable security may then be published on an exchange or other suitable platform for trading the marketable security.

The profile data of the community members may be continually (or periodically) monitored to identify shifts in asset preferences. For example, it may be identified through evaluation of transaction data that 50% of community members are frequenting coffee shop A and 50% of community members are frequenting coffee shop B. The automated asset acquisition agent may adjust the assets held in each coffee shop to reflect the current community preference (e.g., by selling some shares of coffee shop A and buying some shares of coffee shop B, etc.).

New investors may opt-in to the community and the profile data of the new investors may be analyzed along with existing members to identify shifts of the community with the new member. The automated asset acquisition agent may adjust the assets of the fund to reflect identify changes in community asset preference. Thus, the asset pool adjusts as members join and leave the community. These techniques improve the processing efficiency of identifying and acquiring asset based on community preferences and provide timely asset pool adjustments to accommodate changing community makeup and preferences. In an example, the automated asset acquisition agent may adjust the asset pool automatically based on identification of an event (e.g., media coverage of a controversy, etc.). For example, the media may be covering an investigation of environmental abuse by coffee shop A and the automated asset acquisition agent may sell the coffee shop A assets and may use the proceeds to purchase other target asset pool assets (e.g., based on the asset acquisition matrix, etc.).

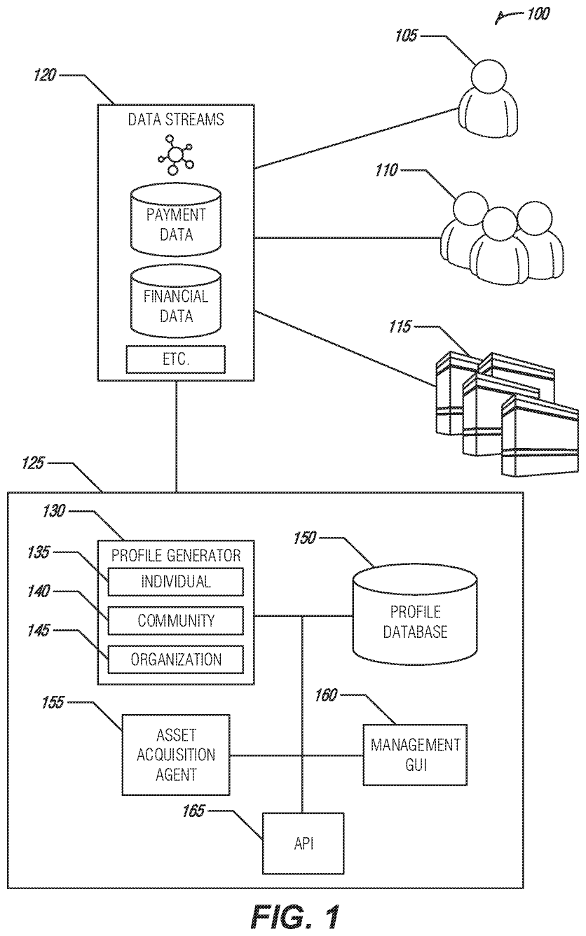

FIG. 1 is a block diagram of an example of an environment 100 and system 125 for a profiling asset acquisition agent, according to an embodiment. The environment 100 may include an individual 105, a community 110, and organizations 115 (e.g., company, financial institution, charity, etc.). The individual 105, community 110, and organizations 115 may generate data in a variety of data streams 120 (e.g., social networks, payment data, financial data, wearable data, etc.).

The environment may include the system 125 which may be communicatively coupled (e.g., via wired network, wireless network, the internet, etc.) to the data streams 120. The system 125 may include a variety of components including a profile generator 130, a profile database 150, an asset acquisition agent 155, a management graphical user interface (GUI) 160, and an application programming interface (API) 165. The profile generator 130 may include a variety of components such as an individual profile generator 135 for analyzing data and generating asset preference profiles for the individual 105, a community profile generator 140 for analyzing data and generating asset preference profiles for the community 110, and an organization profile generator 145 for analyzing data and generating asset profiles for the organizations 115. The API 165 may provide interconnection and interoperability between the system 125 and other systems such as the data streams 120, financial systems, social media networks, etc.

The individual 105 may be a member of the community 110 which is being profiled to determine asset preferences. Each member of the community 110 such as the individual 105 may generate data (e.g., based on activity of the user, data entered by the user, etc.) in the data streams 120. For example, purchase transaction, social media posts, wearable device data, mobile device data, etc. of the individual 105 may be generated that corresponds with an organization 115. For example, wearable device data, payment data, and financial data may be generated when the individual 105 visits coffee shop A. The organizations 115 may generate data in the data streams 120. For example, a publicly traded company may post on social media, submit news releases, release financial data, etc.

The profile generator 130 may obtain information from the data streams 120 and may analyze the data for the individual 105 using the individual profile generator 135, for the community 110 using the community profile generator 140, and for the organizations 115 using the organization profile generator 145. In an example, the profile generator 130 may be a cloud-based data mining tool. The profile generator may be interconnected to a multiplicity of data sources in the data streams 120 via APIs, etc. The profile generator 130 may collect data from the data streams 120 and may mine (e.g., using keyword analysis, natural language processing, etc.) the data using the individual profile generator 135 to identify preferences and patterns for the individual 105. Identified preferences and patterns may be aggregated by the group profile generator 140 to identify commonalities among members of the community 110. The commonalities may be used to create an investment profile which may be used to generate a target asset pool (e.g., a set of possible investments). Inputs may include, by way of example and not limitation, transaction data, social network data, communications data, wearable data, and ambient sensor data.

In an example, the profile generator 130 may use cluster analysis techniques (e.g., k-means, distribution modeling, density-based clustering, etc.) to identify target assets for the community. The profile generator 130 may work in conjunction with the individual profile generator 135 to extract assets from profile data of individuals (e.g., individual 105, etc.) and may determine metrics (e.g., interest level, spending level, visit frequency, etc.) for the asset based on activities identified in the data streams 120 of the individuals. The assets and corresponding metrics of members of the community 110 including the individual 105 may be mapped (e.g., in a dimensional space, etc.) by the profile generator 130 in conjunction with the community profile generator 140. The mapped data points may be analyzed using cluster analysis to identify groupings of assets for the community. An asset corresponding with a grouping of data points may be identified as a target asset for the community 110 by the community profile generator 140. Assets identified as target assets may be added to the target asset pool and may be stored in the profile database 150 as corresponding with the profile of the community 110.

The organization profile generator 145 may generate a profile of securities corresponding to the organizations 115. Inputs may include, by way of example and not limitation, transaction data, news articles, balance sheets, corporate announcements, product announcements, etc. The data may be analyzed using outputs from the individual profile generator 135 and/or the community profile generator 140 to determine securities corresponding to members of the organizations 115 that are relevant to the individual and/or group investment profile. The analysis may use financial and non-financial (e.g., sentiment data, interests, causes, etc.) data elements to determine relevancy of a security to the individual 105 and/or the community 110. The profiles created by the profile generator 130 may be stored in the profile database 150. The profile database 150 may include a data structure for storing and indexing profiles.

The asset acquisition agent 155 may obtain a target profile (e.g., a community profile, an individual profile, etc.) generated by the profile generator 130. In an example, the target profile may include a set of member profiles (e.g., profile of the individual 105, profile of the community 110, etc.). In an example, the target profile may include a set of user profiles in a geographic area (e.g., a community such as community 110 located in a city, etc.).

The asset acquisition agent may determine a set of profile attributes (e.g., spending metrics, visit frequency metrics, sentiment metrics, etc.) for the target profile. In an example, data may be collected from a user profile associated with the target profile (e.g., individual 105, etc.). An asset may be identified as corresponding to a user activity (e.g., a purchase, a social media post, etc.) in the collected data and a profile attribute of the set of profile attributes may be identified using the user activity.

An acquisition target pool may be identified using the set of profile attributes. For example, a target profile for a demographic group may include profile attributes indicating a positive sentiment, frequent visits, and consistent spending at coffee shop A and the stock of coffee shop A may be added to the acquisition target pool based on the profile attributes. In an example, the set of profile attributes may be evaluated using machine learning to identify an asset pattern for the target profile and acquisition target pool may be identified using the asset pattern.

An acquisition matrix may be determined for the acquisition target pool. For example, coffee shop A and coffee shop B may be added to the acquisition target pool and based on coffee shop A having a higher spending metric included in the profile attributes the acquisition matrix may provide a proportionally higher acquisition share compared to coffee shop B. In an example, the set of profile attributes may be evaluated to determine a set of asset preferences corresponding to each member of the acquisition target pool and the acquisition matrix may be determined in proportion to the set of asset preferences.

An asset pool may be generated by acquiring equity of the acquisition target pool based on the acquisition matrix. For example, the acquisition matrix may indicate that the proportion of coffee shop A assets to coffee shop B assets be 2:1 and $30,000 designated for investment to coffee may be allocated $20,000 to acquire shares of coffee shop A and $10,000 to acquire shares of coffee shop B. In an example, a marketable security may be generated based on the asset pool. For example, money pledged by the initial investors of the target profiled based asset pool may be used by the asset acquisition agent 155 and an exchange-trade fund may be generated based on the acquisition target pool assets acquired based on the acquisition matrix. In an example, the marketable security may be presented to an exchange (e.g., stock exchange, trading platform, etc.). For example, the marketable security may be presented for listing on a stock exchange listing exchange-traded funds.

The management GUI 160 may be generated including the acquisition target pool and the acquisition matrix. The management GUI 160 may be displayed on a display device (e.g., included in a mobile device, smartphone, tablet, computer, etc.). An input may be received by the assets acquisition agent 155 via the management GUI 160 indicating a modification to the acquisition matrix and the acquisition matrix may be modified using the received inputs. For example, a user may input acquisition matrix preferences using the management GUI 160 and the asset acquisition agent 155 may aggregate the received inputs and analyze the inputs to determine a modification to the acquisition matrix. In another example, a fund manager may be presented with the management GUI 160 and may provide inputs altering the acquisition matrix and the asset acquisition agent 155 may alter the acquisition matrix and acquire assets based on the modified acquisition matrix.

The asset acquisition agent 155 may adjust the asset pool as profile attributes of the target profile change (e.g., as members are added to and/or removed from the community 110, as preferences of the community 110 change, etc.). The asset acquisition agent 155 may work in conjunction with the profile generator 130 to monitor the target profile to identify changes that may trigger (e.g., based on a profile attribute being outside of a threshold, etc.) rebalancing of the asset pool. In an example, an indication that the target profile has been modified may be received. The set of profile attributes may be updated for the target profile and the acquisition target pool may be modified based on the updated set of profile attributes. In an example, the acquisition matrix may be modified based on the updated acquisition target pool and the asset pool may be regenerated using the modified acquisition matrix. In an example, the acquisition matrix may be modified based on the updated set of profile attributes.

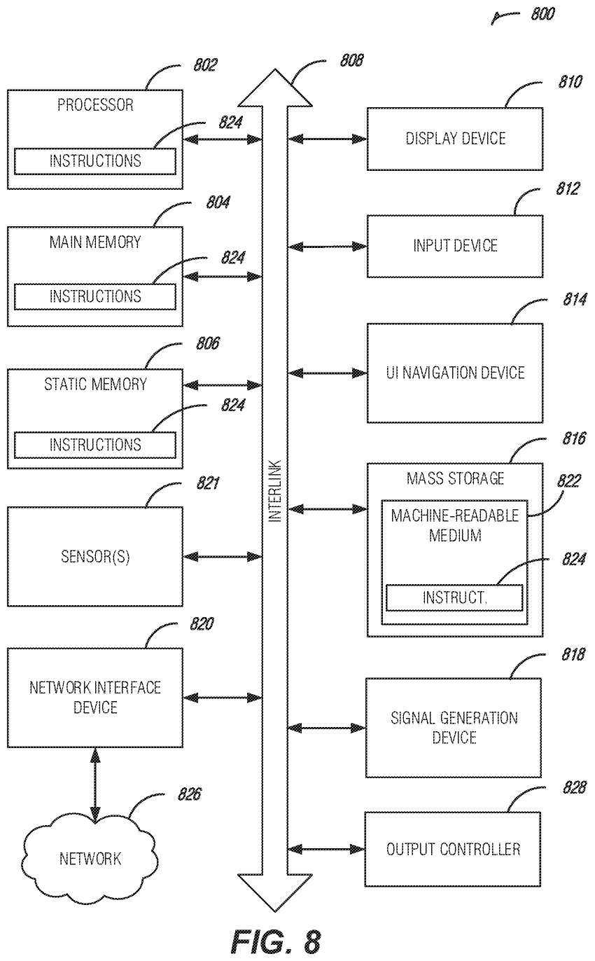

The profile generator 130, the asset acquisition agent 155, the individual profile generator 135, the community profile generator 140, and the organization profile generator 145 may comprise one or more processors (e.g., hardware processor 802 described in FIG. 8, etc.) that execute software instructions, such as those used to define a software or computer program, stored in a computer-readable storage medium such as a memory device (e.g., a main memory 804 and a static memory 806 as described in FIG. 8, a Flash memory, random access memory (RAM), or any other type of volatile or non-volatile memory that stores instructions), or a storage device (e.g., a disk drive, or an optical drive). The components may be implemented in one or more computing devices (e.g., a single computer, multiple computers, a cloud computing platform, a virtual computing platform, etc.). Alternatively, the profile generator 130, the asset acquisition agent 155, the individual profile generator 135, the community profile generator 140, and the organization profile generator 145 may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure.

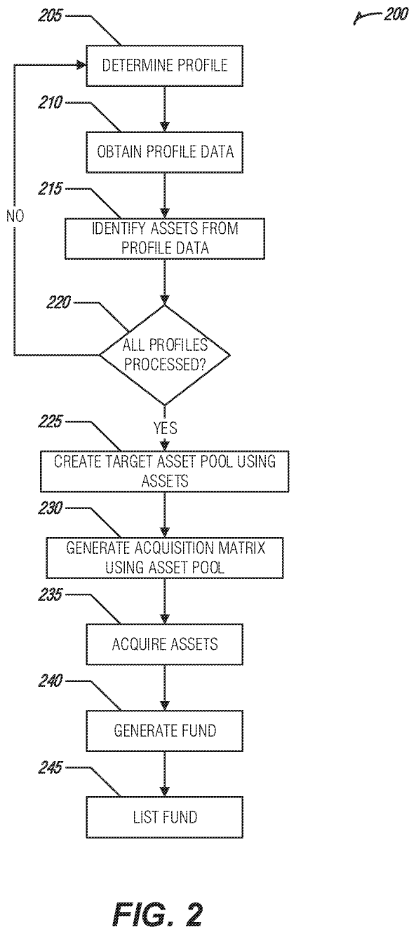

FIG. 2 illustrates a flow diagram of an example of a process 200 for a profiling asset acquisition agent, according to an embodiment. The process 200 may provide features as described in FIG. 1. A profile to be analyzed may be determined (e.g., at operation 205). For example, the profile may be for users born between a first date and a second date. The profile may be used to select user profiles matching selection criteria. For example, user profiles of users born between the first date and the second date may be selected for analysis.

Profile data for the user profile may be obtained (e.g., at operation 210). The user profile may include data streams containing records of user activity (e.g., financial records, payment data, social media activity, wearable device data, etc.). For example, data from a wearable device associated with a user profile may be obtained and may be used to determine location data for the user corresponding to the user profile. The profile data may be used as inputs to a machine learning algorithm (e.g., k-means, etc.) that may identify assets and metrics corresponding to the asset. For example, the user activity data may be analyzed using cluster analysis to determine that the user frequently visits coffee shop A.

The analysis of the profile data may identify assets of interest to the user corresponding with the user profile (e.g., at operation 215). For example, the company stock of coffee shop A may be identified and an asset of interest for the user based on the frequency with which the user visits coffee shop A. In another example, analysis of the profile data (e.g., financial data, payment data, etc.) for the user may indicate that the user spends 20% of disposable income at warehouse club A and the company stock of warehouse club A may be identified as an asset of interest based on the percentage of income the user spent at warehouse club A.

Profile data is collected and analyzed for each member of the community until it has been determined that all profiled have been analyzed (e.g., at decision 220). Assets and metrics associated with the assets identified from each of the user profiles of the community may be aggregated and analyzed as a group (e.g., using cluster analysis, etc.) to identify similarities in asset interest among the user profiles of the community. The similarities may be used to create a target asset pool using the identified assets (e.g., based on highest interest level, largest cluster, etc.) (e.g., at operation 225). For example, an interest in coffee shop A may be identified (e.g., based on spending, frequency of visits, etc.) in a plurality of user profiles and the company stock of coffee shop A may be added to the target asset pool based on the number of users identified as having an interest in coffee shop A and a total intensity of the interest (e.g., as determined by total spending by community members, average frequency of visits, etc.).

An acquisition matrix may be generated using the target asset pool (e.g., at operation 230). The acquisition matrix may indicate how an investments in the target asset pool are to be allocated. For example, the acquisition matrix may indicate that an investment in the target asset pool should be allocated 25% to wholesale club A stock and 75% to coffee shop A stock. In an example, the acquisition matrix may be determined based on a relative interest level for each asset of the target asset pool. For example, it may be determined that the community collectively spends three times as much (e.g., per month, per year, etc.) at coffee shop A than wholesale club A. In an example, an acquisition matrix data structure may be generated. The acquisition matrix data structure may include nodes that may, for example, represent members of the target asset pool. The acquisition matrix data structure may include relationships and parameters such as, for example, relationships between user profiles and target asset pool members and preferences of users relating to members of the target asset pool. In an example, the acquisition matrix data structure may be self-referencing and the acquisition matrix may be self-generated by the acquisition matrix data structure by evaluating internal relationships and preferences.

An automated asset acquisition agent may acquire the assets in the target asset pool according to the acquisition matrix (e.g., at operation 235). For example, the automated asset acquisition agent may obtain $10,000 and may acquire $7,500 in company stock of coffee shop A and $2,500 of company stock of warehouse club A based on the acquisition matrix. The automated acquisition agent may generate a marketable fund (e.g., exchange-traded fund, mutual fund, etc.) based on the acquired assets (e.g., at operation 240). The automated asset acquisition agent may list the marketable fund on a trading platform (e.g., at operation 245). For example, an exchange traded fund named “community preferred stock fund” may be created with ticker symbol CPSF and listed on a stock trading exchange.

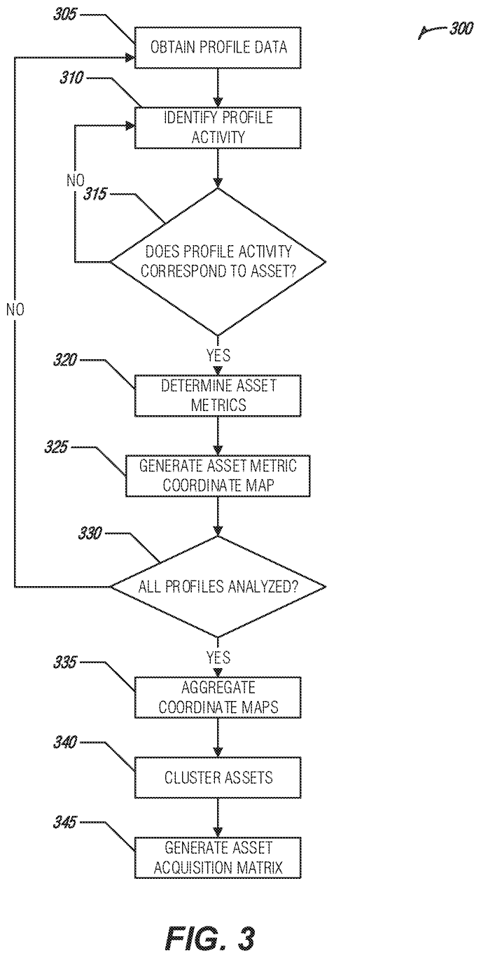

FIG. 3 illustrates an example of a profiling process 300 for a profiling asset acquisition agent, according to an embodiment. The process 300 may provide features as described in FIG. 1. A profile to be analyzed may be determined (e.g., at operation 305). For example, the profile may include users born between a first date and a second date. The profile may be used to select user profiles matching selection criteria. For example, user profiles of users born between the first date and the second date may be selected for analysis.

Profile data for the user profile may include data streams containing records of user activity (e.g., financial records, payment data, social media activity, wearable device data, etc.). The data streams may be analyzed to identify user activities (e.g., at operation 310). The user activities may be analyzed to determine if an activity corresponds to an asset (e.g., at operation 315). For example, data from a wearable device associated with a user profile may be obtained and may be analyzed to determine that a user corresponding to the user profile visited coffee shop A which may be determined to correspond to company stock of coffee shop A. In another example, the wearable device data may indicate that the user visited a park which may not correspond to an asset. However, non-asset corresponding data may be collected and evaluated to identify general preferences (e.g., likes, dislikes, etc.) of the user. The information may be stored in a profile for the user. Additional user activities may be analyzed until all assets have been identified.

Asset metrics may be determined for an identified asset (e.g., at operation 320). For example, an activity indicating that the user visited coffee shop A may trigger an analysis of other data such as, for example, payment data to determine an amount spent by the user at coffee shop A. In another example, additional user activities indicating the user visited coffee shop A may be identified and used to determine a frequency of the user's visits. In an example, the metrics may be used to determine an interest level of the user for an asset. For example, the user may spend twenty dollars a week at coffee shop A which may be determined to be the highest and most frequent dollar amount spent by the user resulting coffee shop a receiving the highest interest ranking. In an example, the interest level may be a ranking of identified assets by the corresponding metrics (e.g., highest dollar spend, most frequent visits, etc.). In an example, the metrics may be used as input to a ranking algorithm and the assets may be assigned an interest level based on a combination of factors (e.g., spend/frequency, etc.).

An asset metric coordinate map may be generated mapping the asset and metrics in a dimensional space (e.g., at operation 325). In an example the metric may be one or more selected metrics. In another example, the metric may be an interest level generated using one or more metrics. The map may be a representation (e.g., based on space, etc.) of assets and corresponding interest in the assets. A map may be generated for each user profile including assets identified from analysis of the user profile data. Processing of user profiles may continue until it has been determined that all user profiles of the community have been analyzed (e.g., at decision 330).

The coordinate maps for each user profile of members of the community may be aggregated (e.g., at operation 335). In an example, the data from each coordinate map may be combined into a single coordinate map for the community. The community coordinate map may indicate relative interest in assets of the community as a whole. In an example, the community coordinate map may be analyzed using cluster analysis to identify assets having the greatest interest (e.g., at operation 340). The cluster analysis may include a constraint indicating a maximum number of assets to add to a target asset pool and the cluster analysis may identify a set of target assets to include in the pool based on a set of selection criteria (e.g., highest spending by the community, most visited by the community, highest interest score for the community, etc.). In an example, a user profile may include an investment amount of a user and the investment amount may be applied as a weight asset when generating the community coordinate map.

An asset acquisition matrix may be generated for the target asset pool (e.g., at operation 345). The acquisition matrix may represent relative proportions of assets to be acquired for a given asset acquisition. For example, the asset acquisition matrix may indicate that 20% of an investment should be used to purchase shares of coffee shop A and 10% of an investment should be used to purchase shares of warehouse club A. The asset acquisition matrix may be determined based on a relative community interest among members of the target asset pool. In an example, a user profile may include an investment amount of a user and the investment amount may be applied as a weight to the asset acquisition matrix. An automated asset acquisition agent may use the asset acquisition matrix when automatically acquiring assets for the community.

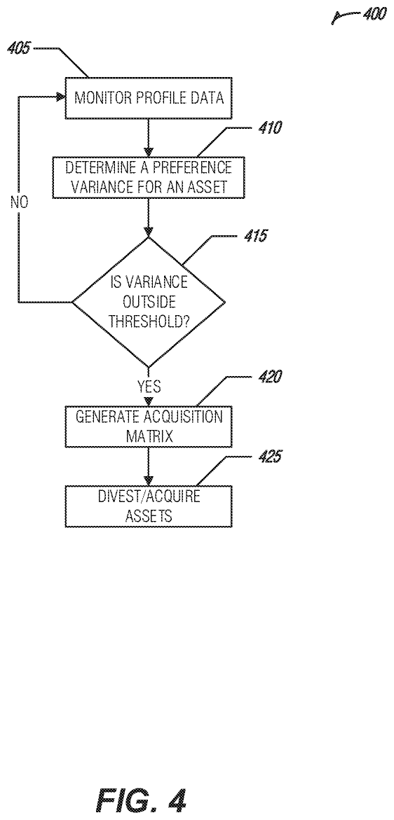

FIG. 4 illustrates an example of a process 400 for profile adjustment for a profiling asset acquisition agent, according to an embodiment. The process 400 may provide features as described in FIG. 1. The process 400 may adjust the assets underlying a fund generated by an automated asset acquisition agent. User profile data of members of a community that was analyzed to determine target assets for acquisition for the fund by the automatic asset acquisition agent may be monitored for updates (e.g., at operation 405).

A preference variance may be determined for an asset (e.g., at operation 410). The profile data may be analyzed to determine assets and corresponding metrics. The assets and corresponding metrics may be mapped. The maps for each user profile of the community may be combined and analyzed using, for example, cluster analysis to identify assets of interest to the community. An interest level may be determined for each asset (e.g., based on money spent by the users, frequency of visits, identified sentiment, etc.). The assets and sentiments may be compared to a current acquisition matrix (or the current underlying asset mix) to determine a variance.

The variance may be compared to a threshold (e.g., percent of difference from current asset mix and currently determined asset/interest level, etc.) to determine if the variance is outside the threshold (e.g., at decision 415). If the variance is outside the threshold an acquisition matrix may be generated (e.g., at operation 420). For example, the variance may indicate that a current allocation of funds of 20% to coffee shop A company stock should be adjusted to 30% while a current allocation of 10% to warehouse club A should be adjusted to 0%.

The automated asset acquisition agent may divest and/or acquire assets as needed to bring the asset allocation of the fund into compliance with the acquisition matrix (e.g., at operation 425). For example, the automated asset acquisition agent may divest (e.g., sell, etc.) the 10% allocation to company shares of warehouse club A and may use the funds to acquire an additional 10% of coffee shop A company stock. Thus, the asset allocation may be adjusted by the automated asset acquisition agent as interests of the community change (e.g., as members join, members leave, member activities change, etc.).

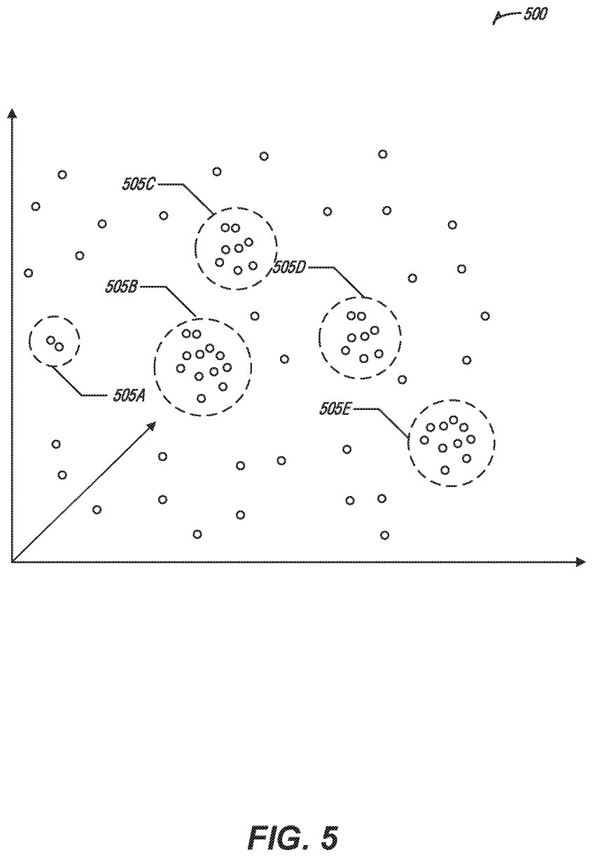

FIG. 5 illustrates an example of asset metric clustering 500 for a profiling asset acquisition agent, according to an embodiment. The asset metric clustering 500 may provide features as described in FIG. 1. Assets and associated metrics identified from user profiles of a community may be mapped in a dimensional space. The map may be analyzed using cluster analysis to identify asset metric cluster 505A, 505B, 505C, 505D, and 505E, collectively asset metric clusters 505. The asset clusters may represent shared interests among members of the community. An asset corresponding to the asset metric clusters 505 may be identified as target assets and may be added to a target asset pool. Characteristics (e.g., size of the identified cluster, relative position of the asset metric clusters 505, etc.) of the asset metric clusters 505 may be used in creating an acquisition matrix for the target asset pool. The acquisition matrix may be used by an automated asset acquisition agent to acquire the assets included in the target asset pool.

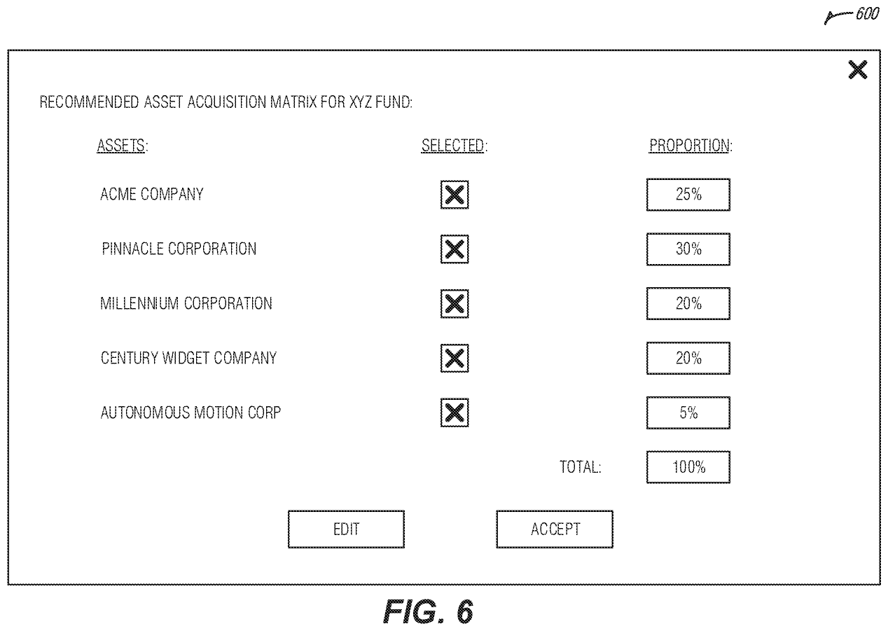

FIG. 6 illustrates an example of a graphical user interface (GUI) 600 for a profiling asset acquisition agent, according to an embodiment. The GUI 600 may provide features as described in FIG. 1. The GUI 600 may include a variety of user interface elements (e.g., checkboxes, textboxes, buttons, etc.) that may be used to receive input from a user. The GUI 600 may be generated including a target asset pool and an acquisition matrix. The GUI 600 may be output for display on a display device (e.g., a screen of a smartphone, tablet, computer, etc.). The user may select user interface elements to modify the target asset pool (e.g., by unchecking a box next to a target asset, etc.) and modify the acquisition matrix (e.g., by changing a value in a textbox indicating an allocation proportion, etc.).

Modifications to the target asset pool and/or acquisition matrix may be received by an automated asset acquisition agent. The automated asset acquisition agent may modify the acquisition matrix based on the inputs received. In an example, the automated asset acquisition agent may receive multiple inputs (e.g., from multiple users, etc.) and may aggregate the inputs to modify the acquisition matrix. In an example, the automated acquisition matrix may determine an investment amount for a user submitting a modification and may apply the investment amount as a weight to the received inputs when modifying the acquisition by aggregating inputs.

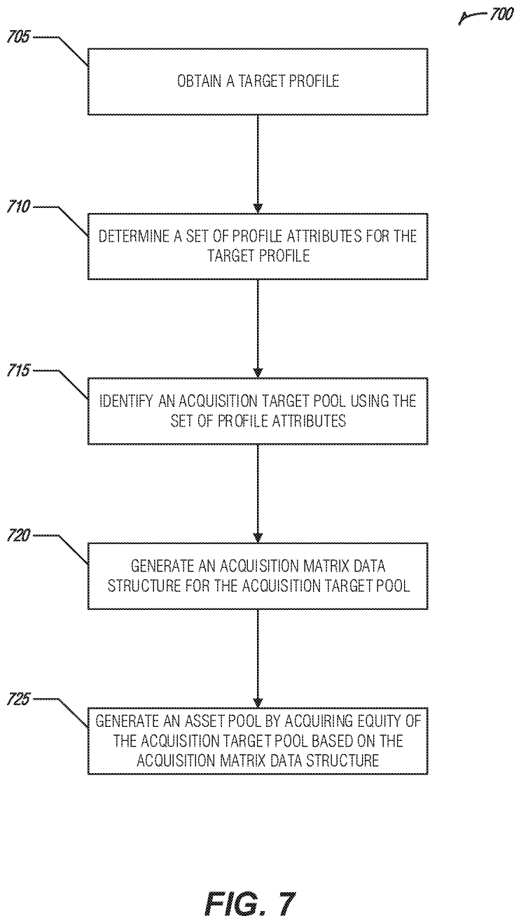

FIG. 7 illustrates an example of a method 700 for a profiling asset acquisition agent, according to an embodiment. The method 700 may provide features as described in FIGS. 1-6.

At operation 705, a target profile may be obtained. In an example, the target profile may be obtained by a computing device. In an example, the target profile may include a set of member profiles. In an example, the target profile may include a set of user profiles in a geographic area.

At operation 710, a set of profile attributes may be determined for the target profile. In an example, data may be collected from a user profile associated with the target profile. An asset corresponding to a user activity may be identified in the collected data and a profile attribute of the set of profile attributes may be identified using the user activity.

At operation 715, an acquisition target pool may be identified using the set of profile attributes. In an example, the set of profile attributes may be evaluated using machine learning to identify an asset pattern for the target profile and the identification of the acquisition target pool may use the asset pattern.

At operation 720, an acquisition matrix data structure may be generated using the acquisition target pool. In an example, the set of profile attributes may be evaluated to determine a set of asset preferences corresponding to each member of the acquisition target pool and the acquisition matrix data structure may include a relationship between members of the acquisition target pool and corresponding members of the set of asset preferences. In an example, a graphical user interface may be generated including a graphical representation of the acquisition target pool and the acquisition matrix data structure. The graphical user interface may be displayed on a display device. An input may be received via the graphical user interface indicating a modification to the acquisition matrix data structure and the acquisition matrix data structure may be modified using the received input.

At operation 725, an asset pool may be generated by acquiring equity of the acquisition target pool based on the acquisition matrix data structure. In an example, a marketable security may be generated based on the asset pool and the marketable security may be presented to an exchange. In an example, the marketable security may be presented via a computer network.

In an example, an indication may be received indicating that the target profile has been modified. The set of profile attributes may be updated for the target profile and the acquisition target pool may be modified based on the update set of profile attributes. In an example, the acquisition matrix data structure may be modified based on the update acquisition target pool and the asset pool may be regenerated using the modified acquisition matrix data structure.

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

1. A system comprising:
at least one processor; and
memory including instructions that, when executed by the at least one processor, cause the at least one processor to perform operations to:
obtain target profiles;
determine sets of profile attributes for the target profiles, the sets of profile attributes including establishments and expenditures at the establishments;
evaluate the sets of profile attributes using a machine learning algorithm to identify a common asset pattern among the target profiles, wherein the evaluation identifies common behaviors of users associated with the target profiles based on the establishments and the expenditures at the establishments for particular assets and asset types as components of the common asset pattern, wherein the common behaviors change over time and are identified based on:
gathering location data associated with the users visiting the establishments;
determining a frequency at which the establishments are visited based on the gathered location data;
determining activity data, which includes the expenditures at the establishments, in response to gathering the location data such that the common asset pattern is identified based on the establishments, the frequency at which the establishments are visited, and the expenditures at the establishments; and
applying the machine learning algorithm to the activity data of the target profiles corresponding to the location data included in the set of profile attributes obtained from devices associated with the target profiles;
identify an acquisition target pool based on the common asset pattern identified with the machine learning algorithm;
evaluate the set of profile attributes and the activity data to determine a set of asset preferences corresponding to each member of the acquisition target pool, wherein the set of asset preferences includes a preferred asset mix directed toward a first portion of the target pool and a second portion of the target pool;
generate an acquisition matrix data structure for the acquisition target pool based on the set of asset preferences, the acquisition matrix data structure being self-referencing and including:
nodes that represent members of the acquisition target pool; and
a relationship between the members of the acquisition target pool and corresponding members of the set of asset preferences based in part on the common behaviors and the preferred asset mix, wherein an acquisition matrix is self-generated by the acquisition matrix data structure;
generate an asset pool by acquiring equity of the acquisition target pool based on the acquisition matrix;
allocate separate portions of the equity to the first portion of the target pool and the second portion of the target pool; and
present the asset pool for listing on an electronic financial exchange system.

2. The system of claim 1, wherein the instructions further include instructions to:
generate a graphical user interface including a graphical representation of the acquisition target pool and the acquisition matrix data structure;
display the graphical user interface on a display device;
receive an input via the graphical user interface indicating a modification to the acquisition matrix data structure; and
modify the acquisition matrix data structure using the received input.

3. The system of claim 1, wherein the instructions further include instructions to:
receive an indication that the target profile has been modified;
update the set of profile attributes for the target profile; and
modify the acquisition target pool based on the updated set of profile attributes.

4. The system of claim 3, wherein the instructions further include instructions to:
modify the acquisition matrix data structure based on the updated acquisition target pool; and
regenerate the asset pool using the modified acquisition matrix data structure.

5. The system of claim 1, wherein the instructions to determine the sets of profile attributes further includes instructions to:
collect data from user profiles associated with the target profiles;
identify an asset corresponding to a user activity in the collected data; and
identify a profile attribute of the set of profile attributes using the user activity.

6. The system of claim 1, wherein the target profile includes a set of member profiles.

7. The system of claim 1, wherein the target profile includes a set of user profiles in a geographic area.

8. The system of claim 1, wherein the instructions further include instructions to:
generate a marketable security based on the asset pool; and
present the marketable security to an exchange.

9. At least one machine readable medium including instructions for a profiling asset acquisition agent that, when executed by a machine, cause the machine to perform operations to:
obtain, by a computer system, target profiles;
determine sets of profile attributes for the target profiles, the sets of profile attributes including establishments and expenditures at the establishments;
evaluate the sets of profile attributes using a machine learning algorithm to identify a common asset pattern among the target profiles, wherein the evaluation identifies common behaviors of users associated with the target profiles based on the establishments and the expenditures at the establishments for particular assets and asset types as components of the common asset pattern, wherein the common behaviors change over time and are identified based on:
gathering location data associated with the users visiting the establishments;
determining a frequency at which the establishments are visited based on the gathered location data;
determining activity data, which includes the expenditures at the establishments, in response to gathering the location data such that the common asset pattern is identified based on the establishments, the frequency at which the establishments are visited, and the expenditures at the establishments; and
applying the machine learning algorithm to the activity data of the target profiles corresponding to the location data included in the set of profile attributes obtained from devices associated with the target profiles;
identify an acquisition target pool based on the common asset pattern identified with the machine learning algorithm;
evaluate the set of profile attributes and the activity data to determine a set of asset preferences corresponding to each member of the acquisition target pool, wherein the set of asset preferences includes a preferred asset mix directed toward a first portion of the target pool and a second portion of the target pool;
generate an acquisition matrix data structure for the acquisition target pool based on the set of asset preferences, the acquisition matrix data structure being self-referencing and including:
nodes that represent members of the acquisition target pool; and
a relationship between the members of the acquisition target pool and corresponding members of the set of asset preferences based in part on the common behaviors and the preferred asset mix, wherein an acquisition matrix is self-generated by the acquisition matrix data structure;
generate an asset pool by acquiring equity of the acquisition target pool based on the acquisition matrix data structure;
allocate separate portions of the equity to the first portion of the target pool and the second portion of the target pool; and
present the asset pool for listing on an electronic financial exchange system.

10. The at least one machine readable medium of claim 9, wherein the instructions further include instructions to:
generate a graphical user interface including a graphical representation of the acquisition target pool and the acquisition matrix data structure;
display the graphical user interface on a display device;
receive an input via the graphical user interface indicating a modification to the acquisition matrix data structure; and
modify the acquisition matrix data structure using the received input.

11. The at least one machine readable medium of claim 9, wherein the instructions further include instructions to:
receive an indication that the target profile has been modified;
update the set of profile attributes for the target profile; and
modify the acquisition target pool based on the updated set of profile attributes.

12. The at least one machine readable medium of claim 11, wherein the instructions further include instructions to:
modify the acquisition matrix data structure based on the updated acquisition target pool; and
regenerate the asset pool using the modified acquisition matrix data structure.

13. The at least one machine readable medium of claim 9, wherein the instructions to determine the sets of profile attributes further includes instructions to:
collect data from user profiles associated with the target profiles;
identify an asset corresponding to a user activity in the collected data; and
identify a profile attribute of the set of profile attributes using the user activity.

14. The at least one machine readable medium of claim 9, wherein the instructions to identify the acquisition target pool using the set of profile attributes further includes instructions to:
evaluate the set of profile attributes using machine learning to identify an asset pattern for the target profile, wherein identification of the acquisition target pool uses the asset pattern.

15. The at least one machine readable medium of claim 9, wherein the instructions to generate the acquisition matrix data structure for the acquisition target pool further includes instructions to:
evaluate the set of profile attributes to determine a set of asset preferences corresponding to each member of the acquisition target pool, wherein the acquisition matrix data structure includes a relationship between members of the acquisition target pool and corresponding members of the set of asset preferences.

16. The at least one machine readable medium of claim 9, wherein the instructions further include instructions to:
generate a marketable security based on the asset pool; and
present, via a computer network, the marketable security to an exchange.

17. A method comprising:
obtaining, by a computing device, target profiles;
determining sets of profile attributes for the target profiles, the sets of profile attributes including establishments and expenditures at the establishments;
evaluating the sets of profile attributes using a machine learning algorithm to identify a common asset pattern among the target profiles, wherein the evaluation identifies common behaviors of users associated with the target profiles based on the establishments and the expenditures at the establishments for particular assets and asset types as components of the common asset pattern, wherein the common behaviors change over time and are identified based on:
gathering location data associated with the users visiting the establishments;
determining a frequency at which the establishments are visited based on the gathered location data;
determining activity data, which includes the expenditures at the establishments, in response to gathering the location data such that the common asset pattern is identified based on the establishments, the frequency at which the establishments are visited, and the expenditures at the establishments; and
applying the machine learning algorithm to activity data of the target profiles corresponding to location data included in the set of profile attributes obtained from devices associated with the target profiles;
identifying an acquisition target pool based on the common asset pattern identified with the machine learning algorithm;
evaluating the set of profile attributes and the activity data to determine a set of asset preferences corresponding to each member of the acquisition target pool, wherein the set of asset preferences includes a preferred asset mix directed toward a first portion of the target pool and a second portion of the target pool;
generating an acquisition matrix data structure using the acquisition target pool based on the set of asset preferences, the acquisition matrix data structure being self-referencing and including:
nodes that represent members of the acquisition target pool; and
a relationship between the members of the acquisition target pool and corresponding members of the set of asset preferences based in part on the common behaviors and the preferred asset mix, wherein an acquisition matrix is self-generated by the acquisition matrix data structure;
generating an asset pool by acquiring equity of the acquisition target pool based on the acquisition matrix data structure;
allocating separate portions of the equity to the first portion of the target pool and the second portion of the target pool; and
presenting the asset pool for listing on an electronic financial exchange system.

18. The method of claim 17, further comprising:
generating a graphical user interface including a graphical representation of the acquisition target pool and the acquisition matrix data structure;
displaying the graphical user interface on a display device;
receiving an input via the graphical user interface indicating a modification to the acquisition matrix data structure; and
modifying the acquisition matrix data structure using the received input.

19. The method of claim 17, further comprising:
receiving an indication that the target profile has been modified;
updating the set of profile attributes for the target profile; and
modifying the acquisition target pool based on the updated set of profile attributes.

20. The method of claim 19, further comprising:
modifying the acquisition matrix data structure based on the updated acquisition target pool; and
regenerating the asset pool using the modified acquisition matrix data structure.

21. The method of claim 17, wherein determining the sets of profile attributes further comprises:
collecting data from user profiles associated with the target profiles;
identifying an asset corresponding to a user activity in the collected data; and
identifying a profile attribute of the set of profile attributes using the user activity.

22. The method of claim 17, wherein identifying the acquisition target pool using the set of profile attributes further comprises:
evaluating the set of profile attributes using machine learning to identify an asset pattern for the target profile, wherein identifying the acquisition target pool uses the asset pattern.

23. The method of claim 17, wherein generating the acquisition matrix data structure for the acquisition target pool further comprises:
evaluating the set of profile attributes to determine a set of asset preferences corresponding to each member of the acquisition target pool, wherein the acquisition matrix data structure includes a relationship between members of the acquisition target pool and corresponding members of the set of asset preferences.

24. The method of claim 17, further comprising:
generating a marketable security based on the asset pool; and
presenting, via a computer network, the marketable security to an exchange.
